(19) United States
(12) Patent Application Publication
(10) Pub. No.: US 2026/0235756 A1
(43) Pub. Date: Aug. 13, 2026

(54) DETECTION DEVICE AND CORRESPONDING DETECTION METHOD

(71) Applicant: ams-OSRAM AG, Premstaetten (AT)

(72) Inventor: Johannes HAASE, Wädenswil (CH)

(21) Appl. No.: 19/160,047

(22) PCT Filed: Jan. 24, 2024
(86) PCT No.: PCT/EP2024/051602

§ 371 Date: Aug. 27, 2025

(30) Foreign Application Priority Data
Apr. 3, 2023 (DE) 10 2023 108 527.1

(51) Int. Cl. G01S 17/58; G06F 3/01

(52) U.S. Cl. CPC G01S 17/58; G06F 3/011

(57) ABSTRACT

A simple and energy-efficient detection device is disclosed, comprising an emitter configured to emit coherent electromagnetic radiation and an electronic control-unit connected to the emitter and configured to modulate the emitter to send electromagnetic radiation, receive electromagnetic radiation, generate an output signal based on a change in the property of the light emitter, wherein further at least two optical delay matters are connected to the emitter, the emitter is configured to emit electromagnetic radiation through the at least two optical delay matters, and the optical delay matters differ by their individual delay values.

### TECHNICAL FIELD

The invention relates to a detection device. It also relates to a detection method using a detection device.

This patent application claims the priority of German patent application 10 2023 108 527.1, the disclosure content of which is hereby incorporated by reference.

### BACKGROUND

Modern electronic devices for human usage have different options for human-machine interface action. Buttons, knobs, levers, and variations of them are the more classical solutions. In the last two decades the most prevalent, widespread, and adopted solution is the touch interface. With the touch interface other options such as gesture controls on a surface like tapping, swiping but also gesture controls in the proximity of a sensor or surface have been adopted in a broad range of electronic devices.

Switching from larger mechanical interfaces to touch or proximity sensitive interfaces comes with various benefits from a constructions point of view. Less moving parts are beneficial for assembly line planning, sourcing of parts and the overall lifetime and build quality is also positively affected. The implications for design and usability are also large, e.g. housings with closed surfaces or insulation against moisture.

Therefore, human-machine interfaces with the modern variants of touch and gesture input can be found in every market sector. Home appliances, cars, mobile phones, earphones, wearables like rings, glasses, wristwatches, wristbands, medical equipment and headpieces for virtual reality, augmented reality are just a small selection of the large scope where such interfaces where integrated. Touch interfaces are mostly realized by capacitive or resistive sensors, however there is a third solution for proximity and touch sensors that is light interference and reception of it.

For the third solution an emitter is needed per sensor and each sensor has a port for the light in the interface device. What is also needed are computing units to interpret the reflected signal. This is a radar approach that works for proximity, distance, and touch detection. Fundamental basis for this light radar is self-mixing interference. This effect is the interference of light from an emitter with its back-reflected prior emitted light. The change in properties of the emitter is detectable and interpretable to locate objects, track movements, calculate distances or proximities. However, this solution is more energy consuming than resistive and capacitive sensors.

When working with electromagnetic radiation/waves and its detection or manipulation by matter one of the dominant analytical tools is Fourier transform. The mathematical operation allows transforming a function of frequency into a functions of time and vice versa and thus making it easier to interpret or distinguish by simpler computing operations or interpretable by human beings.

Looking back, many of above-mentioned devices are battery powered or come in battery powered variants, hence energy consumption is a concern. This trend is also intensifying. In general energy consumption for touch interfaces is higher than for mechanical interfaces. Where mobile phones lasted weeks on battery power supply in simpler models, todays phones with added features, large screens and touch sensors are merely lasting a day on battery power.

### SUMMARY

An objective of the present invention is to provide a simpler and more energy efficient detection device. Another objective of the present inventions is to provide a device solving or partially solving the mentioned problems as well as providing an alternative solution for a detection device and a method using such a device as well as detecting movements through the present inventions.

These objects are achieved with the subject-matter of the independent claims. Further developments and embodiments are described in the dependent claims. Specifically, a detection device according to claim 1 and a corresponding method according to claim 11 are given.

A detection device is provided by an emitter configured to emit coherent electromagnetic radiation. The detection device also comprises an electronic control-unit connected to the emitter, wherein the control-unit is configured to
modulate the emitter to send electromagnetic radiation,
receive electromagnetic radiation, and
generate an output signal based on a change in the property of the light emitter,

wherein further
at least two optical delay matters are connected to the emitter,
the emitter is configured to emit electromagnetic radiation through the at least two optical delay matters, and
the optical delay matters differ by their individual delay values.

Expedient embodiments are subject of the dependent claims and the following description.

It is integral for the detection device that at least two optical delay matters are connected to the emitter, wherein the emitter is configured to emit electromagnetic radiation through the at least two optical delay matters. The optical delay matters differ by their individual delay values they are offsetting the passing electromagnetic radiation.

This configuration enables the light source to emit and receive at least two signals for self-mixing interferometry which allows them in conjunction with the control-unit to measure distances, track velocity as well as touch, tap and swipe motions with the detection device while using less energy for the process due to the single light source connected to two delay matters. This is in comparison to conventional designs, where two light sources would be installed for detectable signals. In detection devices with self-mixing interference the main power consumer is the required constant activation of the emitter or light source. Therefore, this solution is very beneficial for power consumption (which is relatively reduced) and the overall parts count and design of the device (which also is reduced or simplified). The emitters are sources of light that emit coherent electromagnetic radiation (typically laser light), and in this case can be able to modulate the electromagnetic radiation emitted in its properties.

The modulation of these properties should be controlled and initialized by a control-unit that is connected to an emitter and designed to modulate the electromagnetic radiation emitted. This is commonly referred to as chirping the emitter up and down.

Radiation that has both electric and magnetic fields and travels in waves. It comes from natural and man-made sources. Electromagnetic radiation can vary in strength from low energy to high energy. It includes radio waves, microwaves, infrared light, visible light, ultraviolet light, x-rays, and gamma rays.

Self-mixing interference (SMI) is sometimes also referred as back-injection interference. In principal it is achieved by partial reflection of previously emitted light by an object back into an emitter and subsequently causing a modulation of the electromagnetic radiation emitted or produced by the emitter. This interaction causes the change in the property of the emitter. It can equivalently be described as change in the electromagnetic radiation emitted by the emitter.

This method of detection works in particular for frequency modulated continuous wave (FMCW) emitters coupled with SMI detection. While the wavelength of the laser is modulated by a control-unit, the back-reflected light causes a disturbance of the frequency, and this can further be interpreted for detection of an object.

In some embodiments, the control-unit is configured to detect a change in a junction voltage of the emitter and determine from the change in junction voltage the movement of the object. A property other than a wavelength (and an optical power since it is related to the emission frequency) that is affected by self-mixing is typically an emitter junction voltage. Therein, it is noted that both the output frequency and the junction voltage in consequence show a dependency with the movement and are therefore detectable property changes.

A detection device may further comprise ports at the end of each optical delay matter configured to release electromagnetic radiation in and/or out of the detection device and to and/or from the emitter through the optical delay matter.

These ports are advantageous for sealing the electronics from different outside influences apart from the electromagnetic waves, light and its reflection. Different materials and surfaces can be used here, the only criteria is a transparency for the emitted electromagnetic radiation originating from the emitter. These can very well be aligned in material transparency for the electromagnetic radiation and the spectrum of the emitter.

To use a single emitter for SMI detection the basic principle is to split the signal of the laser into various delay lines to separate the different seem-mixing interference ports in the Fourier space (frequency domain) .

According to the invention, the emitter can be a laser, an infra-red laser, a diode and/or a vertical-cavity surface-emitting laser (VCSEL). The usage of different light sources is advantageous for the needed or desired spectrum in electromagnetic radiation depending on the desired detection. Simple diodes are especially advantageous for low manufacturing prices and simple designs. Infra-red is especially advantageous for devices where human beings are not meant to detect the light with their eyes, for example in human-wearable devices or vital sign tracking, e.g. virtual reality glasses (also includes augmented reality for example for supported work performance). The light source selection is also very beneficial for the usage and detection or optical delay matter selection as they are co-dependent on the emitted electromagnetic spectrum. In these cases lasers offer wide array of properties modulation of their emitted electromagnetic radiation.

VCSEL diodes are characterized by a beam emission that is perpendicular to a main extension plane of a top surface of the VCSEL. The VCSEL diode can be formed from semiconductor layers on a substrate, wherein the semiconductor layers comprise two distributed Bragg reflectors (DBR) enclosing active region layers in between and thus forming a cavity. VCSELs and their principle of operation are a well-known concept and are not further detailed throughout this disclosure. The VCSEL diode can be configured to emit coherent laser light when forward biased, for instance. Suitable alternative emitters include semiconductor lasers such as edge emitters, quantum cascade and quantum dots laser.

In some embodiments optical delay matters comprise of free space, mirrors, optical fibers, tubes, containers filled with transparent liquids or other transparent mediums and/or photonic integrated circuits.

The different options are advantageous for different solutions.

Free space is a very simple and resource limited approach to optical delay, it may be achieved by mirrors with different reflection properties (e.g. percentages on each mirror or within one mirror). This is low in cost and requires no maintenance. Optical fibers offer advantages in being flexible (in orientation and geometry) and building space efficient solutions with readily available materials.

Tubes or containers are a means to store transparent mediums (e. g. gases, fluids, gels, etc.) using one or more mediums. This offers more solutions as well as new use cases as the mediums are temperature sensitive and change properties with temperature such as their phase (liquid, gas, solid and others). One can also change the optical delay value by medium change.

Photonic integrated circuits (PIC) on a flexible and bendable substrate offer a different solution and use up very little space as well as offer a programmable differing of the optical delay.

In some embodiments the detection device according to the invention is setup to ensure: The minimal optical delay value is larger than the coherence length of emitted electromagnetic radiation, or more precisely the coherence length modulated for the emitter by the control-unit. The emitted electromagnetic radiation again is set by the emitter and the control-unit that modulates it.

This is to advantageously use the device and make sure no signals are lost by the resolution of the setup.

Analogously, some embodiments are set up to ensure: The maximum optical delay matter length is limited by the coherence length of emitted electromagnetic radiation, or more precisely the coherence length modulated for the emitter by the control-unit. The emitted electromagnetic radiation again is set by the emitter and the control-unit that modulates it.

Again, this is to advantageously use the device and make sure no signals are lost by the resolution of the setup.

In some embodiments of the detection device the emitter is the singular emitter connected to the at least two and/or all optical delay matters applicable for its electromagnetic radiation within the detection device.

This configuration allows a very low energy consumption of the detection device and might as well be the most power saving design and therefore is an especially preferred design setup.

In some embodiments the length difference or optical delay value of the optical delay matters is at most the maximum distance detectable by the detection ports.

In some embodiments the electronic control-unit is configured to differentiate changes in the properties of the emitter by Fourier transformation and thus splitting it into different delayed signals' contributions.

This advantageously allows easier interpretation of the signal by computers and more accurate detection with less false interpretations after the transformation from a wave function to a time function or vice versa.

A human-machine-interface, a headphone, a pair of head-wearable glasses, a body-wearable ring, a vital sign tracker, an electronic biometry-authenticator, an eye-tracking device, and/or a key comprising a detection device according to one of the mentioned embodiments are possible implementations.

Human-machine interfaces, especially of the wearable or portable type, are benefitting the most from the reduced energy consumption of the mentioned embodiments.

The invention also covers a detection method using a detection device according to one of the mentioned embodiments. Therein, the electronic control-unit is connected to the emitter. The control-unit modulates the frequency of the emitted electromagnetic radiation or is modulating the emitter to send electromagnetic radiation. It also detects a change in a property of the emitter caused by the self-mixing interference with back reflected and previously emitted electromagnetic radiation or is receiving electromagnetic radiation. Subsequently it generates an output signal that comprises information based on the self-mixing interference or is generating an output signal based on a change in the property of the emitter. The emitter emits electromagnetic radiation through at least two optical delay matters connected to the emitter. The optical delay matters are offsetting the passing electromagnetic radiation by their individual delay value-thus delaying the electromagnetic radiation, wherein the passing electromagnetic radiation is delayed by their (the delay matters') individual delay value.

This provides a method for detection with a single emitter compared to more than one and reduces energy consumption for the detection method and usage of the device.

In one embodiment of the detection method the change in a property of the emitter is used to generate an input signal by the control-unit, wherein the control unit Fourier transforms a wave function representing the property of the emitter and allots its time or frequency function signals to one of the delay matters or ports.

The allows different input on a detection device or human-machine interface comprising a detection device of the kind described above.

In another embodiment of the detection method the electronic control-unit uses a band pass filter instead of Fourier transform to distinguish and establish detection or to differentiate changes in the properties of the emitter by an integrated band pass filter, and/or wherein the electronic control-unit uses a band pass filter to allot signals to delay matters or ports.

This provides a simple approach to the detection and reduces the needed computing power and therefor energy consumption.

In another embodiment the detection method allows to distinguish at least two different signals for vital signs, and/or motion of objects or proximity are detected by electromagnetic waves of a singular emitter, or wherein at least two different signals for vital signs or motion of objects or proximity are allotted by the control units for a singular emitter.

This is beneficial for several use cases of human-machine interfaces such as wearable digital watches with a touch screen and added features for vital sign detection as it reduces energy consumption and design complexity.

In summary, the various applications and embodiments described below employ the following measuring principles:
The wavelength of an emitter, in particular a laser source, is modulated in time and the laser light is back-reflected into the emitter cavity by a surface-the touch sensitive surface.
The interference in the emitter cavity creates a beat signal that has a frequency relatable to the distance of the touch surface to the laser.
In Fourier (frequency) space, the beating is visible as a peak.
By touching the surface, the signal will be perturbed, leading to fluctuation in frequency position and intensity of the peak in the Fourier spectrum.
The perturbation of the signal allows for touch detection.

A main principle of the invention is to use a single emitter (in particular a laser source) for multiple self-mixing interference/interferometry (SMI) detection ports. It is suggested to use an optical delay per port to distinguish the different SMI signal ports in Fourier (frequency) space. The low power consumption of a single emitter versus multiple emitters opens a big variety of new possibilities where power consumption is crucial.

More specifically, the signal of a laser source is split into various portions. These different portions can be used for SMI detection as detection ports. On each of the ports, a different optical delay will be applied. The delay allows for a later separation of the signals in Fourier (frequency) space. To enable the Fourier filtering, the signals are advantageously acquired with wavelength sweeps from the laser source in the so-called frequency modulated continuous wave (FMCW) mode. The back-reflected and interfering signal leads to a beating of a frequency that is relatable to the back-reflecting object distance. The depth sensing detection range of each port is given by the spacing of different channels in the Fourier (frequency) domain. The limit to separate SMI channels by delay is given by the coherence length of the laser source.

The required signal filtering signal may happen via Fourier transform or electronic band pass filtering. In particular, electronic filtering with differently adjusted band pass filters may be employed.

In general, using above principles, multiple touch sensitive surfaces and SMI detection ports can be realized with one laser source.

A prominent use case can be a (smart) ring with multiple SMI sensing ports, but only one laser source. To generate the different delays on the various different measurement output ports, an optical fiber or flexible photonic integrated circuit (flex PIC) can be used and wounded up on the ring structure.

In another use case multiple touch surfaces on AR, VR, or XR glasses for scroll and click menu selection control may be realized this way. Similarly, touch surfaces for tap and swipe input may be realized on headphones.

### BRIEF DESCRIPTION OF THE DRAWINGS

FIG. 1 shows an exemplary embodiment of a detection device according to the invention.

FIG. 2 shows an exemplary graph of a Fourier transformed signal of a detection device according to FIG. 1.

FIG. 3 shows another exemplary embodiment of a detection device according to the invention with mirrors as delay matters.

FIG. 4. shows an exemplary scheme of a detection structure in a control unit, in this case with a band pass.

FIG. 5 to FIG. 7 each show an exemplary signal structure of signals of a detection device according to the invention.

FIG. 8 demonstrates exemplary usage of a human-machine interface with an integrated detection device according to the invention.

FIG. 9 show exemplary embodiments of the detection device according to the invention within a human-machine interface.

FIG. 10 to FIG. 12 show exemplary human-machine interfaces with integrated invented detection devices.

### DETAILED DESCRIPTION

In general, the electromagnetic radiation is emitted by an emitter in all the drawings and passes the delay matters. However, as the delay matters and electromagnetic radiation often coincides spatially/geographically, the electromagnetic radiation is often not labelled in the drawings.

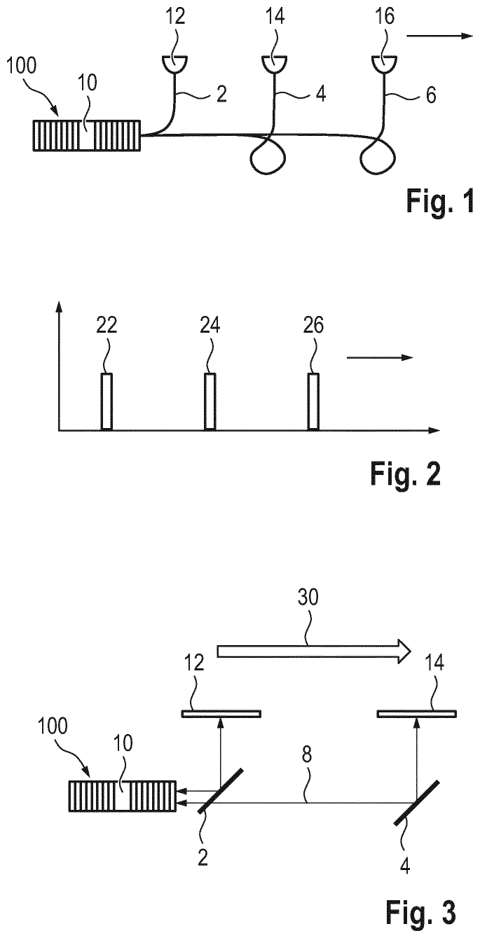

FIG. 1 presents a detection device 100 with optical fibers as optical delay matters 2, 4, 6, comprising: An emitter 10 configured to emit coherent electromagnetic radiation 8 (laser light) and an electronic control-unit connected to the emitter 10. The control-unit is configured to modulate the frequency of the electromagnetic radiation 8 and to detect a change in a property of the emitter 10 caused by the self-mixing interference with back reflected and previously emitted electromagnetic radiation 8. Based on this, an output signal is generated. That output signal comprises information based on the self-mixing interference.

In this embodiment three or more optical delay matters are connected to the emitter 10, wherein the emitter 10 is configured to emit electromagnetic radiation 8 through the three or more optical delay matters. The optical delay matters differ by their individual delay values they offset the passing electromagnetic radiation 8.

FIG. 2 presents a schematic graph of a Fourier transformed signal 22, 24, 26. The abscissa constitutes frequency, and the ordinate constitutes the signal intensity. As reference this signal 22, 24, 26 structure is explained in accordance with the embodiment of FIG. 1, however this does not mean it is limited to the embodiment. In fact it provides a general description of signal 22, 24, 26 structures for the detection device according to the invention. A signal 22, 24, 26 structure like this is possible for any detection device 100 with at least three ports 12, 14, 16. The first signal 22 peak in this example could belong to port 12 of FIG. 1 and the rest likewise to their counterpart. The signal 22, 24, 26 pattern would represent for example an object passing over the detection device starting from port 12 and subsequently the other ports 14 & 16. This would result in the signal 22, 24, 26 structure and in accordance with the spatial/geographic placement of the ports 12, 14, 16 would be descriptive of the movement of an object, a touch sequence, or a swipe motion. To determine the detected signal 22, 24, 26 to be some specific motion or input, a control-unit, or another computing device with the data for the detection device and, e. g., the human-machine interface 200 it is integrated with, could be used. In some embodiments, the control-unit is further configured to extract from the output signal a determined speed of movement, and to control a human-machine interface 200 depending on the speed. Like a sense of direction, the speed of the movement can be extracted and used in an analogous manner.

For example, a slow movement in a given direction is interpreted as an input query to fast forward a media currently being played by a media playback device (media player) at a first speed, while a slow movement in a given direction is interpreted as an input query to fast forward the media at a second higher speed. Alternatively, an increase or decrease rate of sound volume could be adjusted in dependence of the detected speed of the movement. In some embodiments, the control-unit is further configured to extract the information of the determined movement of a user's finger from the output signal, extract information of an identified finger of the user from the output signal, and to select and control the human-machine interface 200 depending on the identified finger and the determined movement. As aforementioned, the control-unit can be configured to output a control signal for different human-machine interfaces 200 of the electronic device depending on which finger has been detected by the detection device. For example, the control-unit is configured to interpret a movement with an index finger along a given orientation as query for adjusting a first feature, e. g. a volume, and a movement with a middle finger along the same orientation as query for adjusting a second feature, e.g. adjusting a bass of sound output via a speaker.

FIG. 3 presents an exemplary embodiment of a detection device according to the invention with an indicated swiping motion 30 of an object or finger. Empowerment to detect a multiplexing of a touch surface with a single emitter 10 (specifically a VCSEL in this case) is given by: The emitter 10 being frequency modulated in its continuous wave (FMCW=Frequency Modulated Continuous Wave) to apply a distance measurement process. The wavelength of the emitter 10, e.g. VSCEL, is modulated in time and the electromagnetic radiation 8 is back reflected into the emitter (10) (its cavity in case of a VSCEL). The back reflection is induced by a surface, e.g. a touch sensitive surface of a human-machine interface 200 (this can be the ports 12, 14, 16). The interference in the emitter 10 (or the cavity of the VCSEL) creates a beat signal which has a frequency relatable to the distance of the surface (touch sensitive surface of a human-machine interface 200). In Fourier space (frequency domain) the beating is visible as a peak. By touching the surface, the signal will be perturbed leading to fluctuation in the Fourier space. This fluctuation is visible in the Fourier space. The perturbation of the signal is the basis for touch detection. Measuring the length in time of the perturbation allows to distinguish between a short tap and a longer touch, both pre-set by the programming of a human-machine interface 200 or the control-unit.

With two surfaces (or two ports 12, 14, 16 or those ports connected or adjusted to the surface) a swipe detection can be done by measuring the time delay between the perturbations of a first signal 22 and a second signal 24. A press and therefore exerting a force on the surface (or a port 12, 14, 16 or that port connected or adjusted to the surface) leads to slight shift of the position of the peak in the Fourier space (frequency domain) and can also be detected.

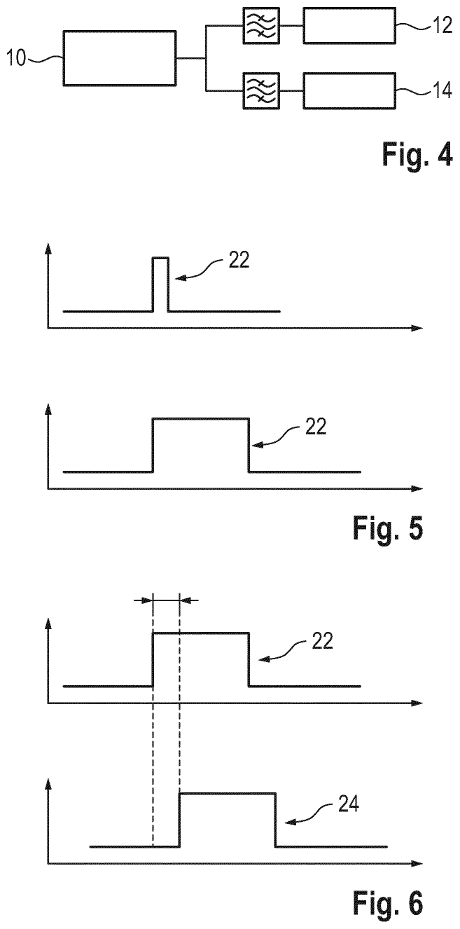

FIG. 4 presents a schematic view of one embodiment of the detection device according to the invention. In this embodiment of the invention the signal by the emitter 10 is split towards two electric band pass filters (waved sketch), wherein the band pass filters are set to the respective frequencies of the corresponding optical delay matters delay length. The filtered signals 22, 24, 26 correspond to the respective ports 12, 14. Any signal changes in amplitude on either of the channels will correspond to a touch, tap, or swipe signal.

Optionally, an amplifier is set within the control-unit and acts as a filter, e.g. the bandpass filter, such that an output of the amplifier substantially only comprises frequency contributions from the self-mixing interference induced by the back-reflected electromagnetic radiation 8 into the emitter 10. The output of the amplifier can be connected to an analog-to-digital converter, ADC, before providing the digitalized signal 22, 24, 26 to the control-unit for generating the output signal. To this end, the control-unit analyzes the digitalized signal, e.g. by means of extracting frequencies and/or amplitudes of the modulation caused by the self-mixing interference and generates the output signal that carries information about said modulation and thus about the detected movement.

FIG. 5 to FIG. 7 describe different graphs for detected and transformed signals 22, 24, 26 in a schematic manner. The abscissa constitutes time, and the ordinate constitutes the signal intensity. FIG. 5 shows the difference in a signal 22 for two different inputs: on the upper graph a tap or click input is demonstrated and on the lower graph with the longer signal peak intensity a touch or hold input is demonstrated.

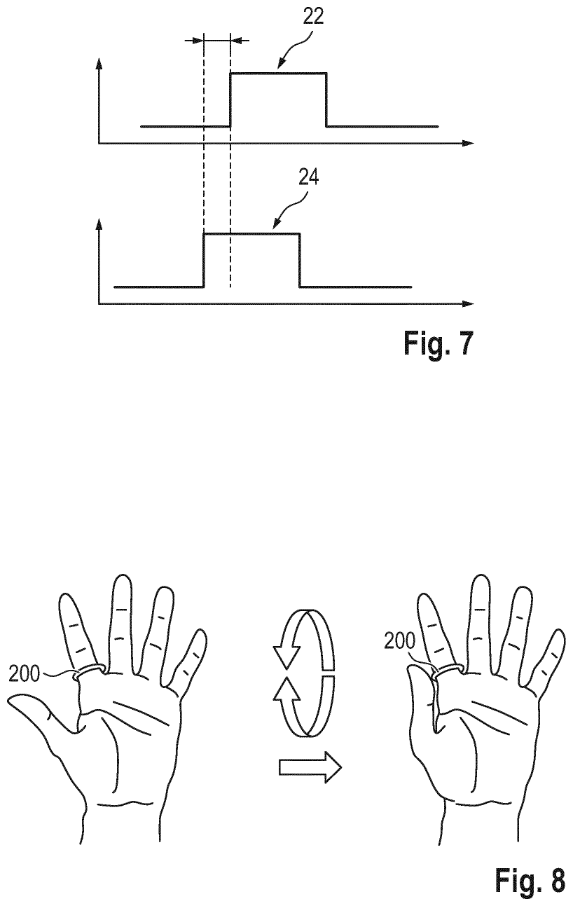

FIG. 6 describes a first signal 22 and a second signal 24 on a parallel time axis. Between both peak intensities is a time delay which is proportional to a scroll speed on a human-machine interface 200 comprising the detection device. This would be schematic for a scroll down, if the first port is on the upper end of a human-machine interface 200 and the second port is placed lower than the first port. From the interpretation of the time delay (between the bracketed lines) it is simple to calculate or derive a speed of the movement. In FIG. 7 the presentation is the same except that the first intensity peak on the timeline is the one corresponding to a port on the human machine interface located lower than the port for the other signal. Therefore, the movement detected is from bottom to top and could therefore be for scrolling up on the human-machine interface 200.

FIG. 8 demonstrates the usage of a human-machine interface 200 comprising a detection device 100 not indicated in the graphic and a touch or swipe motion by the thumb on the human-machine interface 200. All the before mentioned gestures and detections can be used for this human-machine interface 200.

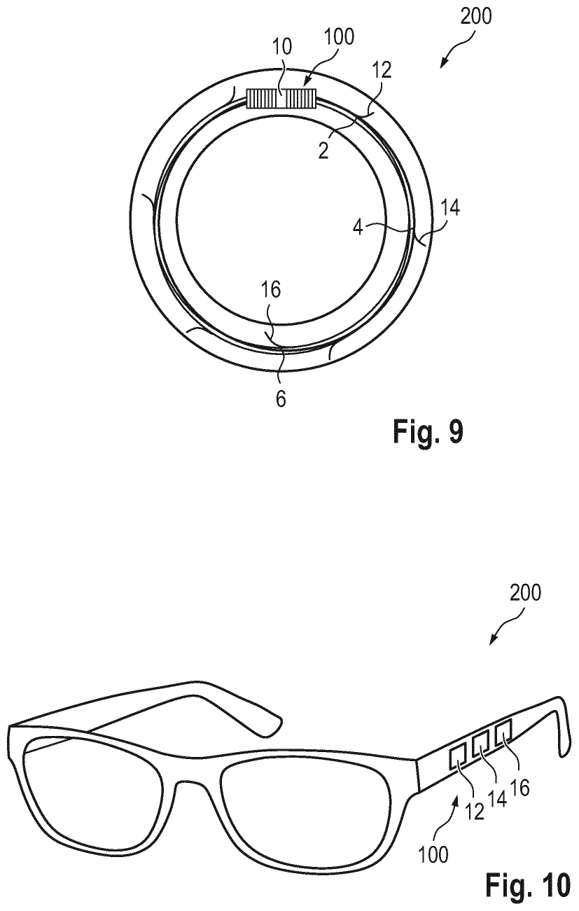

FIG. 9 depicts a detailed view of the human-machine interface 200, in this case a wearable ring. It comprises a detection device 100 comprising the emitter 10 and optical delay matters 2, 4, 6, in this case optical fibers intertwined and located within the wearable ring. Most of the ports 12 and 14 are facing outwards to detect movements for input to the human-machine interface 200 whereas one port 16 faces inwards to monitor vital signs of the wearer.

FIG. 10 depicts a human wearable pair of glasses as a human-machine interface 20 and an integrated detection device 100 with ports 12, 14, 16. This embodiment might be especially beneficial for virtual reality applications and can be combined with the embodiment of FIG. 11.

FIG. 11 depicts a human wearable pair of glasses as a human-machine interface 200 and an integrated detection device 100 with not-shown ports 12, 14, 16. This device is configured to send electromagnetic radiation 8 towards an eye of the wearer from the ports 12, 14, 16. This setup therefore enables eye-tracking and is combinable with the human-machine interface 200 of FIG. 10.

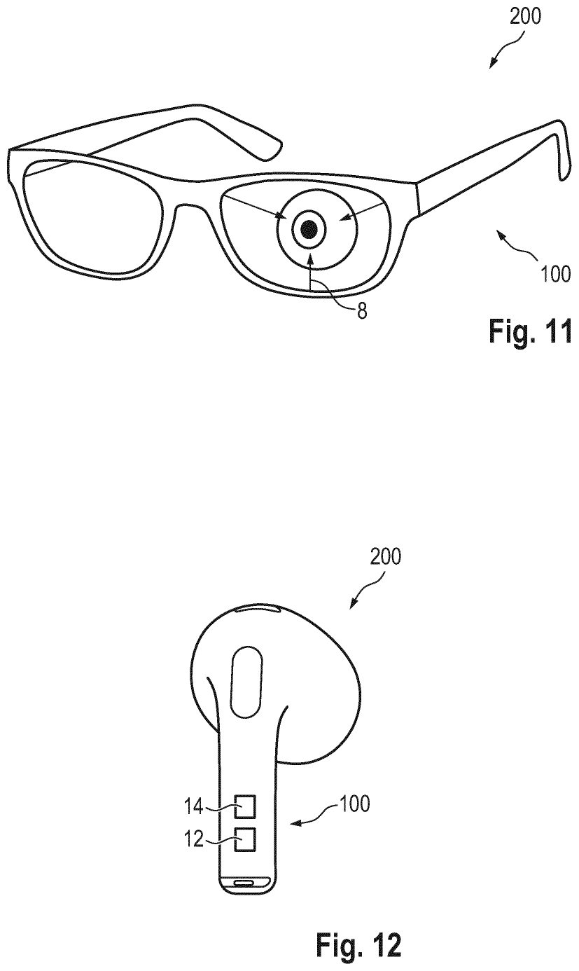

FIG. 12 depicts wearable headphones as a human-machine interface 200 and an integrated detection device 100 with ports 12, 14, 16. The detection device can be beneficially used to generate inputs for the human-machine interface 200 according to the before mentioned input variants and detection procedures.

It will be appreciated that the disclosure is not limited to the disclosed embodiments and to what has been particularly shown and described hereinabove. Rather, features recited in separate dependent claims or in the description may advantageously be combined. Furthermore, the scope of the disclosure includes those variations and modifications, which will be apparent to those skilled in the art and fall within the scope of the appended claims.

The term “comprising”, insofar it was used in the claims or in the description, does not exclude other elements or steps of a corresponding feature or procedure. In case that the terms “a” or “an” were used in conjunction with features, they do not exclude a plurality of such features. Moreover, any reference signs in the claims should not be construed as limiting the scope.

### LIST OF REFERENCE SIGNS

2, 4, 6 delay matter
8 electromagnetic radiation
10 emitter
12, 14, 16 port
22, 24, 26 signal
30 swiping motion
100 detection device
200 human-machine interface

1. A detection device comprising an emitter configured to emit coherent electromagnetic radiation and an electronic control-unit connected to the emitter and configured to:
modulate the emitter to send electromagnetic radiation;
receive electromagnetic radiation:
generate an output signal based on a change in the property of the light emitter, wherein further:
at least two optical delay matters are connected to the emitter;
the emitter is configured to emit electromagnetic radiation through the at least two optical delay matters; and
the optical delay matters differ by their individual delay values.

2. The detection device according to claim 1, comprising ports at the end of each optical delay matter configured to release electromagnetic radiation in and/or out of the detection device and to and/or from the emitter through the optical delay matter.

3. The detection device according to claim 1, wherein the emitter is a laser, an infra-red laser, a laser diode and/or a vertical-cavity surface-emitting laser.

4. The detection device according to claim 1, the optical delay matters comprising free space, mirrors, optical fibers, tubes, containers filled with transparent liquids or other transparent mediums and/or photonic integrated circuits.

5. The detection device according to claim 1, wherein the minimal optical delay value is larger than the coherence length of emitted electromagnetic radiation by the emitter.

6. The detection device according to claim 1, wherein the maximum optical delay matter length is limited by the coherence length of emitted electromagnetic radiation.

7. The detection device according to claim 1, wherein the emitter being a singular emitter is connected to the at least two and/or all optical delay matters applicable for its electromagnetic radiation within the detection device.

8. The detection device according to claim 1, the length difference or optical delay value of the optical delay matters being at most the maximum distance detectable by the detection ports.

9. The detection device according to claim 1, the electronic control-unit being configured to differentiate changes in the properties of the emitter by Fourier transformation.

10. The detection device according to claim 1, the electronic control-unit being configured to differentiate changes in the properties of the emitter by an integrated band pass filter.

11. A Human-machine-interface, a headphone, a pair of head-wearable glasses, a body-wearable ring, a vital sign tracker, electronic biometry-authenticator, eye-tracking device, and/or a key comprising a detection device according to claim 1.

12. A detection method using a detection device according to claim 1, wherein the electronic control-unit is connected to the emitter, and wherein the following steps are performed:
modulating the emitter to send electromagnetic radiation;
receiving electromagnetic radiation; and
generating an output signal based on a change in the property of the emitter,
wherein further the emitter emits electromagnetic radiation through at least two optical delay matters connected to the emitter, and wherein the passing electromagnetic radiation is delayed by their individual delay value.

13. The detection method according to claim 12, wherein the change in a property of the emitter is used to generate an input signal by the control-unit, wherein the control unit Fourier transforms a wave function representing the property of the emitter and allots its frequency function signals to one of the delay matters or ports.

14. The detection method according to claim 12, wherein the electronic control-unit uses a band pass filter to allot signals to delay matters or ports.

15. The detection method according to claim 11, wherein at least two different signals for vital signs or motion of objects or proximity are allotted by the control units for a singular emitter.
